(19) United States
(12) Patent Application Publication
(10) Pub. No.: US 2023/0069165 A1
(43) Pub. Date: Mar. 2, 2023

(54) BYZANTINE FAULT TOLERANT PRE-PREPROCESSING FOR STATE MACHINE REPLICATION

(71) Applicant: VMware, Inc., Palo Alto, CA (US)

(72) Inventors: Teodor PARVANOV, Sofia (BG); Ittai ABRAHAM, Tel Aviv (IL); Kashfat Khan, Palo Alto, CA (US); Yulia SHERMAN, Herzliya (IL); Yehonatan BUCHNIK, Herzliya (IL)

(21) Appl. No.: 17/465,830

(22) Filed: Sep. 2, 2021

(51) Int. Cl. G06F 9/448; H04L 9/32; G06F 16/27

(52) U.S. Cl. CPC G06F 9/4498; G06F 16/27; H04L 9/3247

(57) ABSTRACT

In some embodiments, a first replica sends a message to second replicas for pre-processing of an operation. The first replica receives pre-processing results from the second replicas. A pre-processing result is generated by pre-processing the operation using a first state. The first replica analyzes the pre-processing results to determine whether an agreement on a validated pre-processing result is received. When it is determined the agreement on the validated pre-processing result is received, the first replica performs a consensus protocol stage with the second replicas to order the request in an order of execution of requests that defines when to execute the request with respect to another request at the second replicas. Information for the validated pre-processing result is provided to the set of second replicas to determine whether contention results between the first state and a second state that is based on the order of execution of requests.

### BACKGROUND

State machine replication (SMR) is used for building a fault-tolerant distributed computing system where the system provides a service whose operations and state are replicated across multiple nodes, known as replicas. The state machine replication systems may employ complex state machines. When implemented in the Blockchain space (e.g., using a ledger), a state machine is referred to as an execution engine that can enable arbitrary smart contracts and validation procedures to be performed. As the logic of the execution engines becomes more complex, some problems may result. For example, loss of system liveness may occur in the execution engine due to non-determinism, and also starvation and unfair service may result. The loss of system liveness may result in the system halting and not being able to process requests for operations. The execution engine in state machine replication requires that the engine be deterministic. Determinism can be explained in that if each execution engine starts from the same initial state, and if all execution engines execute the same sequence of operations, then the states of the correct executions will remain the same. Non-determinism results when an execution engine starts from the same initial state, executes the same sequence of operations, but comes up with a different state as a result. Starvation and unfair service is where some requests may receive results that are delayed or slow due to the processing of other requests. However, as execution engines become more complex, there is an elevated risk that some non-deterministic bug will result. Non-determinism may cause the state machine replication system to lose system liveness and halt, recovery from which may require a costly manual intervention. Also, the execution engine is sequential. That is, the operations that are ordered using a consensus protocol are executed sequentially. However, the sequential execution may not be optimal for fairness and service level guarantees. For example, an “elephant” operation may take a long time to execute, which may cause small “mice” operations to be stalled while waiting for the elephant operation to finish execution.

### BRIEF DESCRIPTION OF THE DRAWINGS

With respect to the discussion to follow and to the drawings, it is stressed that the particulars shown represent examples for purposes of illustrative discussion, and are presented to provide a description of principles and conceptual aspects of the present disclosure. In the accompanying drawings:

FIG. 1 depicts a system for implementing a state machine replication-based computing system according to some embodiments.

FIGS. 2A and 2B depict an overview of the preprocessing process among entities in the system according to some embodiments.

FIG. 3 depicts a simplified flowchart of a method for pre-processing the result according to some embodiments.

FIG. 4 depicts an example of processing that is performed at a primary replica according to some embodiments.

FIG. 5 depicts an example of processing that is performed at a non-primary replica according to some embodiments.

### DETAILED DESCRIPTION

In the following description, for purposes of explanation, numerous examples and specific details are set forth to provide a thorough understanding of embodiments of the present disclosure. Some embodiments as expressed in the claims may include some or all the features in these examples, alone or in combination with other features described below, and may further include modifications and equivalents of the features and concepts described herein. Note that some explanations herein, may reflect a common interpretation or abstraction of actual processing mechanisms. Some descriptions may abstract away complexity and explain higher level operations without burdening the reader with unnecessary technical details of well understood mechanisms. Such abstractions in the descriptions herein should be construed as inclusive of the well understood mechanism.

A state machine replication-based computing system may use a pre-processing engine that may pre-process a request received from a client in a pre-processing stage. The computing system may receive multiple requests that can be pre-processed in parallel. In the pre-processing, a service operation requested by a client in the request may be optimistically executed by the pre-processing engine. The optimistic execution may be referred to as pre-processing, but executes the operation as would be performed in an execute stage after ordering. After the pre-processing, the requests may be ordered using a protocol, such as a Byzantine fault tolerant (BFT) consensus protocol. Because requests may have been executed in parallel, it is possible the state may be stale or outdated based on the ordering is accessed by the requests in the pre-processing stage. Accordingly, the pre-processing result for a request is validated based on the ordering. If validated, the request may be committed, such as to a ledger, or if not validated, the request may not be committed or aborted. In contrast to the Background, which executed service operations for the requests after ordering of the requests (e.g., in an order-execute process), the service operation for the request may be pre-processed before ordering in an optimistic pre-processing-order-verify process.

The pre-processing may be performed in a trusted manner that requires an agreement of a number of replicas, such as (f+1), to validate the pre-processing, where f is a number of allowed faulty replicas. That is, the pre-processing results in a pre-processing stage may be first validated in a way that is Byzantine fault tolerant before entering the request into the BFT consensus stage. The validation may involve validating whether f+1 identical pre-processing results are received and signed by replicas. The f+1 identical pre-processing results may be a validated pre-processing result. Because the pre-processing stage requires replicas to reach consensus regarding a validated pre-processing result at an early stage, the request could be retried, aborted, or re-performed without using the pre-processing.

The pre-processing functionality may not be part of the BFT consensus protocol, which makes the pre-processing agnostic to the BFT protocol that is used. Once the pre-processing is validated, the requests may be ordered using the BFT consensus protocol. Once ordered, a validated pre-processing result may be checked for any contention that may have resulted due to the pre-processing. If no contention is found, the validated pre-processing result may be committed, such as to the ledger. If not, another action may be performed, such as the validated pre-processing result may be aborted, or the operation is retried.

When using a key-value store to maintain the state, the pre-processing may be performed at the key value storage layer and may be agnostic to the software programming, such as smart contract language, being implemented, such as on a ledger. The pre-processing may be performed once and the software code that is implemented on top of the key value store will have pre-processing implemented. Thus, different languages that may be used for smart contract execution may use the same infrastructure for the pre-processing as described herein. Also, the client may not control the pre-processing validation. Rather, the system provides the trust using the validation of the pre-processing results and the signatures in the pre-processing stage. This is different from allowing a client to choose the validation policy.

The pre-processing may address the problem of non-determinism by aborting a request if different replicas attain different pre-processing results. It is then possible to try and re-execute the request until all replicas agree. This may not solve the non-determinism problem but may be used when some rare non-deterministic bugs exist by aborting the execution at an early stage. The approach may allow deterministic executions to continue to operate normally while aborting the non-deterministic executions.

Accordingly, the pre-processing of requests may improve the performance of the system especially when sequential operation may result in starvation and unfair service or non-deterministic bugs result as described in the Background. The pre-processing may be performed in parallel and allow short tasks to complete quickly while allowing long-lived executions to execute in the background.

### System Overview

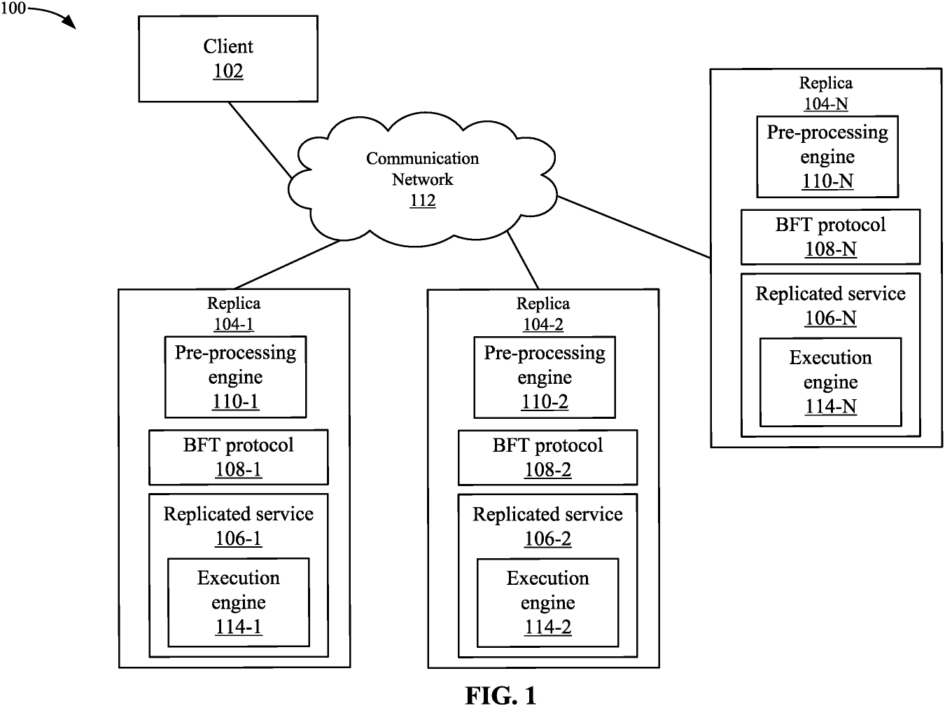

FIG. 1 depicts a system 100 for implementing a state machine replication-based computing system according to some embodiments. System 100 includes a client 102 and N replicas 104-1, 104-2, ..., 104-N (collectively referred to as replicas 104). Replicas 104 may be interconnected via a communication network 112. Each replica 104 may be a physical or virtual machine that is configured to run an instance of a replicated service 106 (respectively replicated service 106-1, replicated service 106-2, ... , replicated service 106-N). Examples of replicated service 106 include a data storage service, a blockchain service storage, etc. Replicated service 106 includes an execution engine 106 (e.g., execution engine 114-1, execution engine 114-2, and execution engine 114-N) that can execute operations for the service. Client 102 consumes replicated service 106 by submitting requests for service operations to a replica 104. The system may use a protocol, such as a Byzantine fault tolerance (BFT) protocol, to agree on a sequence for executing the operations for requests that are received. Byzantine fault tolerance refers to the ability of a computing system to endure arbitrary (e.g., Byzantine) failures that would otherwise prevent the system’s components from reaching consensus on decisions critical to the system’s operation. In the context of state machine replication (SMR) (e.g., a scenario where a system provides a service whose operations and state are replicated across multiple nodes, known as replicas), BFT protocols are used to ensure that non-faulty replicas are able to agree on a common order of execution for client-requested service operations. This, in turn, ensures that the non-faulty replicas will execute the client operations in an identical and thus consistent manner.

The operation for the request is performed by replicas 104 by executing the request (possibly using preprocessing as described below). When the order is agreed upon, the request is committed to update the state of the state machine replication system to reflect the results of the execution. The commitment of an operation may indicate a quorum of replicas has voted on or agreed on the request sent by a primary replica 104.

To ensure that the execution of the operation for the request submitted by client 102 is sequenced by replicas 104 in an identical fashion and thus consistent service states are maintained, the state machine replication system may run a protocol on each replica 104, such as a BFT protocol (respective BFT protocol implementations 108-1, 108-2, ..., 108-N). Examples of BFT protocols include practical BFT (PBFT), scalable BFT (SBFT), and other protocols. In one example of a protocol, in each view, one replica, referred as a primary replica, sends a proposal for a decision value (e.g., operation sequence number) to the other non-primary replicas and attempts to get 2f + 1 replicas to agree upon the proposal, where f is the maximum number of replicas that may be faulty.

As mentioned above, pre-processing may be performed by replicas 104. The pre-processing may be performed by pre-processing engines 110-1 to 110-N. As discussed above, pre-processing engine 110-1 may be separate from BFT protocol implementation 108. This allows the logic of pre-processing engine 110 to be agnostic to the BFT protocol that is used.

In some embodiments, a pre-processing request message for pre-processing of the client request may be sent to all replicas 104 in system 100. Then, a primary replica 104 may collect the pre-processing results and validate that the pre-processing results can be trusted. For example, the results (e.g., a hash of the results) that are generated by each pre-processing engine 110 may be signed by a replica 104 and then sent to the primary replica 104. If the primary replica 104 collects a number (e.g., f+1) of the same signed pre-processing results by other replicas, a the f+1 identical pre-processing results may be validated. If the pre-processing results are not validated, another action may be performed, such as the request may be retried or aborted. The following will now describe the pre-processing process in more detail.

### Pre-processing Process Overview

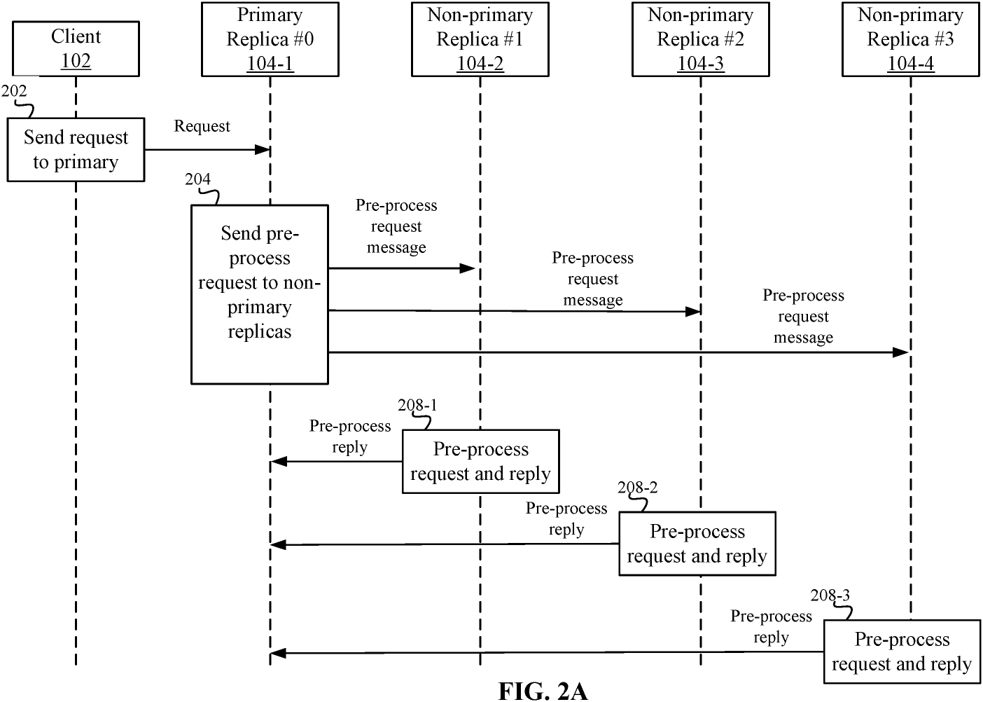

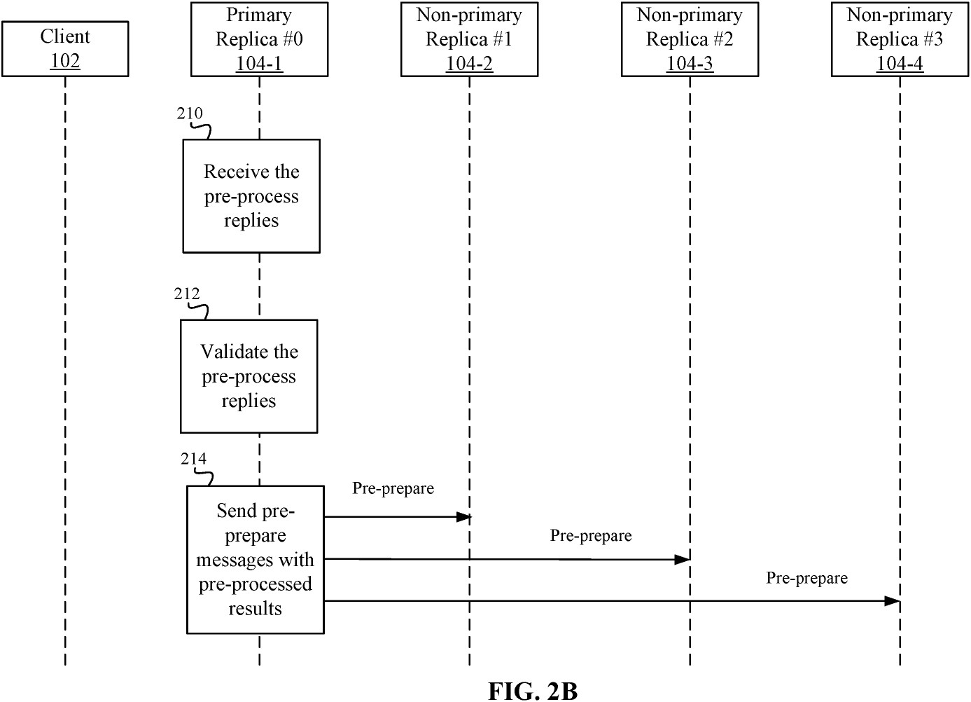

FIGS. 2A and 2B depict an overview of the preprocessing process among entities in system 100 according to some embodiments. It will be understood that messages sent in system 100 may be encrypted and decrypted using cryptographic protocols to provide proof of trust in the system. At 202, a request from client 102 is received at a primary replica #0 104-1. The request may be a demand for a service operation to be performed by system 100. As described, the service operation for the request may be executed, such as by program code that implements application logic. The execution may be referred to differently, such as by executing the request, executing a service operation for the request, executing a command, etc. When pre-processing of the request is described, the service operation is executed in a pre-processing stage that allows service operations for multiple requests to be executed in parallel. Details of an example of execution of a request will be described below.

After receiving the request at primary replica 104-1, at 204, a pre-process request message is sent from primary replica 104-1 to non-primary replicas, such as non-primary replica #1 104-2, non-primary replica #2 104-3, and non-primary replica #3 104-4 in this example. Although three non-primary replicas are shown, other numbers of non-primary replicas may be appreciated. In some embodiments, the pre-process request message may be sent to all replicas in system 100 including primary replica 104-1. The pre-process request may include any information needed to execute the service operation for the request. It will be noted that primary replica 104-1 may perform the same functions as described with respect to non-primary replicas 104-2 to 104-4. That is, primary replica 104-1 may send the pre-process request to itself and perform the processing that is described herein with respect to non-primary replicas 104-2 to 104-4.

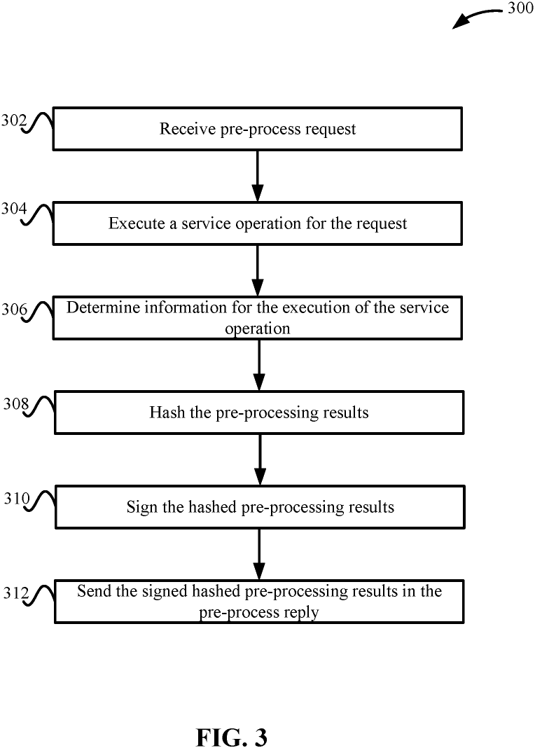

At 208-1, the request is pre-processed by non-primary replica 104-2 and a signed pre-process reply, which may be hashed, is sent back to primary replica 104-1. Similarly, at 208-2 and 208-3, non-primary replicas 104-3 and 104-4 perform the pre-processing and send a reply. The pre-processing may be performed by execution engine 114 by executing a service operation for the request using a state of the state machine replication service/execution engine. Different methods of executing the service operation may be appreciated. For example, FIG. 3 depicts a simplified flowchart 300 of a method for pre-processing the request according to some embodiments. At 302, a pre-process request is received. The request may include an operation to execute, and other parameters that may be needed to pre-process the service operation, such as a client identifier, etc. Then, at 304, the service operation for the request is executed. The service operation may be executed by running program code that implements the logic of an application for the service, and is typically run during an execution phase.

The execution may use the local state of a replica 104 to execute the service operation at the time of the execution. As mentioned above, the operation may be executed optimistically, which may be out of order compared to a final order of execution of requests that is decided after running the consensus protocol. In some embodiments, the state may be maintained in a storage device, such as a key-value store that may be versioned where successive updates to a key may have monotonically increasing version numbers. The execution of the service operation may read information from keys from the key value store and also write information to keys from the key value store. A read-write set may be generated from the keys that are read and the keys in which are written. In some embodiments, multiple pre-processing results may be generated to account for different states that may occur in the execution stage. For example, one or more write sets may be generated. In some examples, multiple write sets may be generated. When the execution stage is reached, one of the write sets may be selected. Also, one of the write sets may be modified. The write set that is selected may be based on different factors, such as a state at the execution stage, such as depending on the conflict detection or other execution-engine specific logic. For example, if a pre-execution “times out” between pre- and execution stage, then the system commits a write set that represents a timeout occurred. If, on the other hand, the execution is successful (e.g., no conflicts, no timeouts), then the system commits a write set that represents a successful execution. The read set may be a set of keys (at a version and block height of the ledger) that have been read to produce the write sets. The read set may be used for conflict detection after the ordering of the requests. Accordingly, at 306, information is determined for the execution of the service operation, such as information for the keys that are read and the keys that have information written. This information is stored, such as in memory, for later validation based on the agreed upon ordering of requests. The information is not stored in a ledger or other persistent storage for the service until later validated.

In some embodiments, the pre-processing results may be reduced in size to limit the amount of information that is sent on the network. For example, at 308, the results may be hashed by non-primary replica 104. Then, at 310, the results (e.g., hashed results) may be cryptographically-signed, such as signed by a key of each respective non-primary replica 104. The cryptographically-signed hashes provide primary replica 104-1 with the proof that the result was calculated by that specific replica and thus it could be trusted. At 312, after pre-processing the service operation for the request, a pre-process reply may be sent by non-primary replicas 104 to primary replica 104-1. It is noted that although primary replica 104-1 is described as receiving the replies, another entity, such as a collector, may receive the replies and process the replies as described herein.

Referring to FIG. 2B, at 210, a set of the signed pre-process reply messages are received at primary replica 104-1. The number of reply messages that are received may be one or more depending on which non-primary replicas send replies. Then, at 212, the pre-process replies are validated by primary replica 104-1. In some embodiments, validation of the pre-process replies may require that a number (e.g., f+1, where f is a maximum number of allowed faulty replicas) of identical pre-processing results. Although f+1 is described, other numbers may be appreciated, such as more than f+1. The validation may involve determining that f+1 identical hashes of the pre-processing results are collected. For example, the signed hash results may be decrypted using the public key of each respective non-primary replica 104 (the public keys of which primary replica 104-1 has access). Then, the hashed pre-processing results from all non-primary replicas 104 may be compared (along with the pre-processing results that are generated by primary replica 104-1). If a number of identical results meets a threshold, such as f+1 identical hashed pre-processing results are collected, the identical pre-processing result is validated by primary replica 104-1, which may be referred to as a validated pre-processing result. The above validation may detect problems at the early stage of pre-processing and allow recovery actions to be taken, which will be described in more detail below.

If the pre-processing result is validated, the process may continue as the pre-processing result may be passed to the BFT consensus stage where the request is processed as a regular request that is ordered based on the BFT consensus protocol. Different BFT protocols may use different messaging to perform the BFT consensus stage. In some embodiments, this process is started at 214, where a pre-prepare message is sent with the validated pre-processing result to start the BFT consensus process. The pre-prepare message may be used by the BFT protocol to start the consensus process. The details of the BFT consensus process will not be described as different BFT consensus protocols may be used. However, one difference may be that the validated pre-processing result may be sent from primary replica 104-1 to non-primary replicas 104-2, such as in the pre-prepare message. The validated pre-processing result may be included in the pre-prepare message for later use to determine if contention resulted when the requests are ordered. It is noted that the validated pre-processing result may be included in other messages that are sent during the BFT consensus process or may be sent separately from the BFT consensus protocol. Further, the f+1 signatures may be included in the pre-prepare message to allow non-primary replicas 104 to validate the pre-processing result included in the pre-prepare message. This validation may be performed to determine whether primary replica 104-1 is malicious or not, and will be discussed in more detail below.

The following will now discuss the processing at primary replica 104-1 and then the processing at non-primary replicas 104-2 to 104-4.

### Non-primary Replica Processing

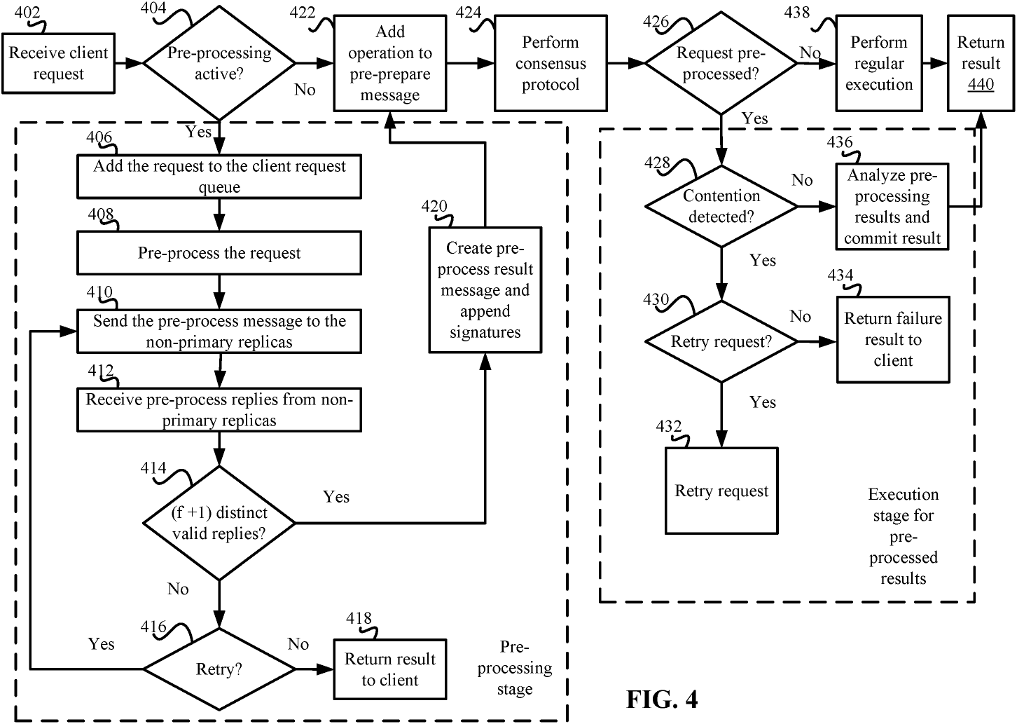

FIG. 4 depicts an example of processing that is performed at primary replica 104-1 according to some embodiments. At 402, primary replica 104-1 receives the client request. At 404, it is determined by primary replica 104 if pre-processing is active or not. For example, some requests may be pre-processed, but the pre-processing may also be bypassed using different methods. In some examples, the request from client 102 may specify whether pre-processing should be performed. For example, each client request may include a specification as to whether pre-processing should be performed for the respective request. This allows pre-processing to be skipped when it is desired, such as when there might be contention between requests that are being submitted in parallel. In other embodiments, a setting at primary replica 104-1 may be configured to designate whether pre-processing is performed or not. If pre-processing is not active, the process may continue at 422 where the pre-prepare message is sent to non-primary replicas 104-2 to 104-4 with the operation to perform from the request to start the BFT consensus protocol process. This pre-prepare message may not include any pre-processing information.

If pre-processing is requested or enabled, a pre-processing stage is performed by primary replica 104-1. At 406, primary replica 104-1 adds the request to the client request queue. For example, multiple requests may be received and are queued to start the pre-processing process. The pre-processing (e.g., execution) of operations may occur in parallel once the requests are processed from the queue. At 408, the request is pre-processed by executing the operation for the request as described above with respect to FIG. 3.

At 410, the pre-processing message is sent to non-primary replicas 104-2 to 104-4. The non-primary replicas 104 pre-process the service operation for the request as described above with respect to FIG. 3. Then, at 412, pre-process replies from non-primary replicas 104-2 to 104-4 are received at primary replica 104-1. A validation of the pre-processing replies is then performed. For example, at 414, it is determined whether a number of distinct valid replies meet a threshold (e.g., f+1). As discussed above, valid replies may be where the pre-processing results are the same for multiple replicas 104 and a distinct reply is from a replica 104 that has not been counted before.

If f+1 valid reply messages are not received, at 416, a recovery action may be performed, such as it may be determined if the request should be retried. The retry may be performed based on different conditions. For example, requests may not be retried at all. However, some requests may be retried a certain number of times. For example, retrying a request may be successful again if there were some disconnections from the network or some non-deterministic results. If the request should be retried, the process reiterates to 410 where another pre-process message is sent to non-primary replicas 104-2 to 104-4. If the request is not retried, at 418, an action may be taken based on the failure, such as the result may be returned to client 102, which may indicate the request failed. Client 102 may determine whether to send the request again after receiving the result that the request failed. Also, it is noted that no reply may be sent to client 102, which may cause client 102 to perform an action, such as to send another request. Validating the requests at the pre-processing stage may detect problems before the execution stage that occurs after the BFT consensus stage. This may be advantageous to minimize any problems that may occur when requests need to be aborted, such as the requests can be retried.

If the reply messages are validated, then at 420, a pre-process result message with appended signatures is created. The pre-process result message may include the validated pre-processing result , which may be the read-write set and the f+1 signatures. The read-write set may be included in different formats. For example, the read-write set that was determined from the validated pre-processing result of primary replica 104-1 may be used because the pre-processing results received from non-primary replicas 104 were hashed and the read and write keys cannot be read. It may also be possible to perform the validations described herein using a hashed write-read set, but for discussion purposes, a read-write set that is not hashed is described. The validated pre-processing result and the f+1 signatures will be validated by replicas 104 to determine if primary replica 104 is acting maliciously, which will be described below. Also, once the ordering of the requests is determined, each replica 104may validate whether contention occurs in the validated pre-processing result after the consensus protocol agrees on an order of execution of the request, which will be described later.

After performing the pre-processing stage, the BFT consensus protocol stage may be entered. At 422, the operation is added to the pre-prepare message with any other information that is needed to reach consensus on the ordering of the request. One difference between the pre-prepare message that is associated with a request that was not pre-processed is that information from the pre-processed result message (e.g., the validated pre-processing result and the f+1 signatures) is added to the pre-prepare message when the request is pre-processed, and not added when pre-processing is not performed.

Then, at 424, the consensus protocol is performed for the request. It will be recognized that different BFT protocols may be used and the output of the BFT consensus protocol process may be agreed-upon sequence ordering of execution for the request with respect to other requests at each replica 104. For example, the requests that are received may be stored in a queue and may be assigned sequence numbers using the protocol. The consensus protocol involves messaging between entities in system 100 to agree on the ordering of the requests. Because the pre-processing stage is separate from the BFT consensus protocol that is used, the pre-processing may be BFT protocol agnostic.

After the consensus protocol process is performed, at 426, it is determined if the request is pre-processed. If the request is pre-processed, an execution stage for the validated pre-processing result is entered. This stage may determine whether contention results for the validated pre-processing result (e.g., the read and write set(s)) based on the ordering that was agreed upon by the consensus protocol process.

At 428, it is determined if contention is detected. Contention detection may detect conflicts in a first state that is used in the pre-processing compared to a second state when the request is ordered. The contention detection may be determined using different methods. In some embodiments, because the ordering is known, the read-write set is validated based on the ordering. Using the read-write set that is included from the pre-process result message, the keys of the read set may be compared to those in the current state of the key-value store in primary replica 104-1. The version of the keys may be compared to ensure that they are still the same. If the versions do not match, the transaction may be marked as invalid as there may have been some contention such as where information for a key was read that was not valid in the first state according to the second state due to the ordering. Different actions may be performed when contention is detected. For example, the request may be retried, a failure result may be returned to the client, or no action may be performed. In some examples, the process proceeds to 430, where it is determined if a retry request should be performed. If a retry request is to be performed, at 432, the request is retried. If not, at 434, an action for the failure may be determined, such as a failure result is returned to client 102. If no action is performed, client 102 may decide what actions to take when no response is received.

Referring back to 428, if contention is not detected, at 436, the validated pre-processing result may be analyzed and a result is committed, such as written to the ledger. That is, a block may be appended to the locally stored ledger and the state of the ledger is updated per the validated pre-processing result. This may include state updates that are based on the keys in the write set. As mentioned above, the pre validated pre-processing result may have included multiple write sets. One of the write sets may be selected at this time based on a state of the execution stage. The selected write set is then committed to the ledger. Then, at 440, the result is returned to client 102.

If the request was not pre-processed, then at 438, regular execution is performed, and the result is committed. That is, the service operation for the request is executed and then committed in this case. The result is also returned at 440.

### Non-primary Replica Processing

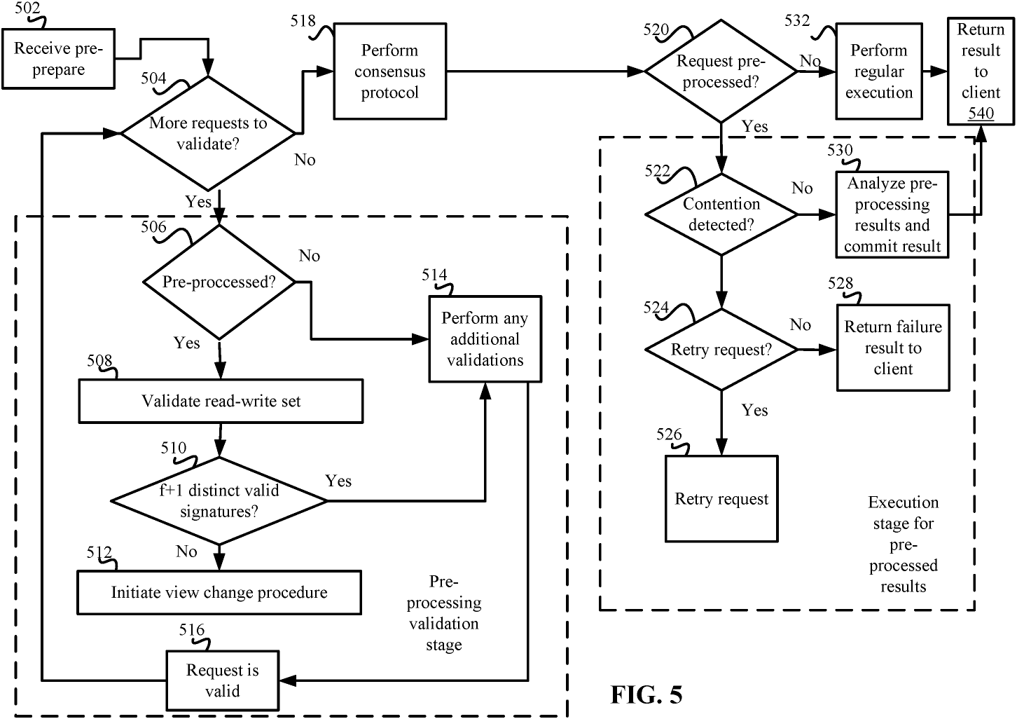

The following processing occurs at non-primary replicas 104 upon receiving a pre-prepare message. FIG. 5 depicts an example of processing that is performed at a non-primary replica 104 according to some embodiments. At 502, a non-primary replica 104-2 receives a pre-prepare message. At 504, it is determined if there are more requests to validate in the pre-prepare stage. The validation validates the pre-prepare message. If not, the process may move to 518 where the consensus protocol process is performed.

If there are requests to validate for the pre-prepare messages, a pre-processing validation stage is performed. For example, at 506, it is determined whether the request was pre-processed. If the request was pre-processed, at 508, it is determined if the validated pre-processing result in the pre-prepare message is valid. The validation may be performed using different methods. For example, the read-write set included in the pre-prepare message is validated with the previously calculated pre-processing results on the respective non-primary replica 104. The validation may determine whether the keys in the read set and the write set match the keys in the locally calculated read-write set. The hashed version of the read-write set may also be validated if that was included in the pre-prepare message. For example, the local read-write set may be hashed and compared to the hashed version received in the pre-prepare message.

At 510, it is determined whether a number of signatures (e.g., f+1) are valid. For example, different methods may be used to validate the f+1 signatures that are received in the pre-prepare message, such as by comparing the signatures to public keys associated with each respective replica 104 to make sure the correct key was used by each replica 104 to sign the pre-processing results. The above validations are performed to make sure there is no malicious behavior being performed by primary replica 104-1. For example, a malicious primary replica 104-1 may change the read-write set that is included in the pre-prepare message or may include signatures that are not valid to represent that the read-write set has been pre-processed and validated.

If the validation fails, at 512, an action in response to the failure may be performed, such as a view change procedure may be initiated by non-primary replica 104. In general, a BFT consensus protocol generally proceeds according to a series of iterations, known as views, and relies on one replica, referred to as a primary, to drive a consensus decision in each view. In each view, the primary sends a proposal for a decision value (e.g., operation sequence number) to the other replicas and attempts to get 2f + 1 replicas to agree upon the proposal (e.g., via voting messages), where f is the maximum number of replicas that may be faulty. If this succeeds, the proposal becomes a committed decision. However, if this does not succeed (generally due to, e.g., a primary replica failure), the replicas enter a “view change” procedure in which a new view is entered, and a new primary is selected. Then, the new primary transmits a new proposal comprising votes received from replicas in the prior view. Accordingly, the view change procedure may be where non-primary replica 104 has detected malicious behavior and moves to another view. Different methods of performing the view change procedure will be appreciated and can be used. However, one change in initiating a view change procedure is that the view change procedure is initiated in the pre-processing validation stage. Conventionally, the view change procedure may have been initiated for other reasons during the consensus protocol stage. However, when malicious behavior is detected in the pre-processing validation stage, the view change procedure may be initiated for the BFT consensus protocol. Different ways of moving to the next view may be used. In some embodiments, a complaint message may be sent to other replicas 104 that may indicate the non-primary replica’s desire to leave the view in the case of detecting malicious behavior. The complaint message may include a reason that indicates malicious behavior may have been found in the pre-processing validation stage. The view change process may proceed in different ways and may or may not result in the replica leaving the current view. Although complaint messages are described, other methods of performing the view change procedure may be appreciated.

If the pre-prepare request is validated (or the request was not pre-processed as determined at 506), at 514, any additional validations that may be required for the pre-prepare message. These validations may not validate any pre-processing information. Then, at 516, assuming the additional validations pass, the process continues to 504 to determine if there are more requests to validate for pre-prepare messages. If not, at 518, the consensus protocol is performed by non-primary replica 104.

After the consensus protocol process is performed, the process may proceed similarly to that described with respect to primary replica 104-1. For example, at 520, it is determined if the request is pre-processed. If the request is pre-processed, an execution stage for the validated pre-processing result is entered.

At 522, it is determined if contention is detected. The contention detection may be determined similarly to that described above except non-primary replica 104 uses its local state of the key-value store to perform the contention detection. As described above, when the request failed during the pre-processing stage, different processes may be performed when contention is detected. For example, the request may be retried, a failure result may be returned to the client, or no action may be performed. In some examples, the process proceeds to 524, where it is determined if a retry request should be performed. If a retry request is to be performed, at 526, the request is retried. If not, at 528, an action for the failure may be determined, such as a failure result is returned to client 102. If no action is performed, client 102 may decide what actions to take when no response is received.

Referring back to 522, if contention is not detected, at 530, the validated pre-processing result is analyzed and a result is committed, such as written to the ledger. This is similar to that described at 436 in FIG. 4 for primary replica 104-1, but this result is written to the ledger on non-primary replica 104. As mentioned above, the validated pre-processing result may have included multiple write sets. One of the write sets may be selected at this time based on a state of the execution stage. The selected write set is then committed to the ledger. Then, at 540, the result is returned to client 102.

If the request was not pre-processed, then at 532, regular execution is performed, and the result is committed. The result is also returned at 540.

### Conclusion

Accordingly, the pre-processing approach may efficiently process requests in situations where pre-processing may be beneficial. For example, if there is a sufficient number of requests being processed in parallel, the efficient utilization of resources may be performed by pre-processing the service operations for the requests. Also, additional benefits may be realized when some execution of operations take a long time compared to others. Finally, if there are a limited number of contentions between pre-processing operations in parallel, then the pre-processing may more efficiently process the requests. Also, the validation of the pre-processing results may be performed early in the process and invalidations can be handled in an improved manner by allowing retrying of requests or other actions. Additionally, the validations provide trust in the pre-processing that is performed.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and operations are illustrated in the context of specific illustrative configurations. Other allocations of functionality are envisioned and may fall within the scope of the disclosure(s). In general, structures and functionality presented as separate components in exemplary configurations may be implemented as a combined structure or component. Similarly, structures and functionality presented as a single component may be implemented as separate components.

Some embodiments described herein can employ various computer-implemented operations involving data stored in computer systems. For example, these operations can require physical manipulation of physical quantities-usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a general purpose computer system selectively activated or configured by program code stored in the computer system. Various general purpose machines may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any data storage device that can store data which can thereafter be input to a computer system. The non-transitory computer readable media may be based on any existing or subsequently developed technology for embodying computer programs in a manner that enables them to be read by a computer system. Examples of non-transitory computer readable media include a hard drive, network attached storage (NAS), read-only memory, random-access memory, flash-based nonvolatile memory (e.g., a flash memory card or a solid state disk), a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and operations are illustrated in the context of specific illustrative configurations. Other allocations of functionality are envisioned and may fall within the scope of embodiments. In general, structures and functionality presented as separate components in exemplary configurations can be implemented as a combined structure or component. Similarly, structures and functionality presented as a single component can be implemented as separate components.

These and other variations, modifications, additions, and improvements may fall within the scope of the appended claims(s). As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations, and equivalents may be employed without departing from the scope of the disclosure as defined by the claims.

What is claimed is:

1. A method for pre-processing a request for an operation in a state machine replication system comprising N replicas, the method comprising:
sending, by a first replica to a set of second replicas, a message for pre-processing of the operation;
receiving, by the first replica, a set of pre-processing results from at least a portion of the set of second replicas, wherein a pre-processing result for a respective second replica is generated by pre-processing the operation using a first state maintained by the respective second replica;
analyzing, by the first replica, the set of pre-processing results from the at least the portion of the set of second replicas to determine whether an agreement on a validated pre-processing result is received; and
when it is determined the agreement on the validated pre-processing result is received, performing, by the first replica, a consensus protocol stage with the set of second replicas to order the request in an order of execution of requests that defines when to execute the request with respect to another request at the set of second replicas, wherein information for the validated pre-processing result is provided to the set of second replicas to determine whether contention results between the first state maintained by the respective second replica and a second state maintained by a respective second replica that is based on the order of execution of requests.

2. The method of claim 1, wherein analyzing the set of pre-processing results to determine whether the agreement on the validated pre-processing result is received comprises:
validating that a specified number of the pre-processing results in the set of pre-processing results are identical to one another.

3. The method of claim 1, wherein analyzing the set of pre-processing results to determine whether the agreement on the validated pre-processing result is received occurs before sending a message to start the consensus protocol stage.

4. The method of claim 1, further comprising:
including the validated pre-processing result and signatures from second replicas in the at least the portion of the set of second replicas that generated the validated pre-processed result in a message that is sent to the set of second replicas during performance of the consensus protocol stage.

5. The method of claim 1, further comprising:
generating, by the first replica, a pre-processing result by pre-processing the operation using a first state maintained by the first replica;
when it is determined the agreement on the validated pre-processing result is received, determining, by the first replica, whether contention results between the first state maintained by the first replica and a second state maintained by the first replica that is based on the order of execution of requests; and
when the contention does not result, updating the second state maintained by the first replica to reflect the execution of the operation using the validated pre-processing result.

6. The method of claim 5, further comprising:
when the contention results, performing an action based on contention resulting without updating the second state maintained by the first replica to reflect the execution of the operation using the validated pre-processing result.

7. The method of claim 1, further comprising:
when it is determined the agreement on the validated pre-processing result is not received, determining whether to retry sending of the message to pre-process the operation.

8. A non-transitory computer-readable storage medium containing instructions for pre-processing a request for an operation in a state machine replication system comprising N replicas, wherein the instructions, when executed, control a computer system to be operable for:
sending, by a first replica to a set of second replicas, a message for pre-processing of the operation;
receiving, by the first replica, a set of pre-processing results from at least a portion of the set of second replicas, wherein a pre-processing result for a respective second replica is generated by pre-processing the operation using a first state maintained by the respective second replica;
analyzing, by the first replica, the set of pre-processing results from the at least the portion of the set of second replicas to determine whether an agreement on a validated pre-processing result is received; and
when it is determined the agreement on the validated pre-processing result is received, performing, by the first replica, a consensus protocol stage with the set of second replicas to order the request in an order of execution of requests that defines when to execute the request with respect to another request at the set of second replicas, wherein information for the validated pre-processing result is provided to the set of second replicas to determine whether contention results between the first state maintained by the respective second replica and a second state maintained by a respective second replica that is based on the order of execution of requests.

9. The non-transitory computer-readable storage medium of claim 8,
wherein analyzing the set of pre-processing results to determine whether the agreement on the validated pre-processing result is received comprises:
validating that a specified number of the pre-processing results in the set of pre-processing results are identical to one another.

10. The non-transitory computer-readable storage medium of claim 8, wherein analyzing the set of pre-processing results to determine whether the agreement on the validated pre-processing result is received occurs before sending a message to start the consensus protocol stage.

11. The non-transitory computer-readable storage medium of claim 8, further operable for:
including the validated pre-processing result and signatures from second replicas in the at least the portion of the set of second replicas that generated the validated pre-processed result in a message that is sent to the set of second replicas during performance of the consensus protocol stage.

12. The non-transitory computer-readable storage medium of claim 8, further operable for:
generating, by the first replica, a pre-processing result by pre-processing the operation using a first state maintained by the first replica;
when it is determined the agreement on the validated pre-processing result is received, determining, by the first replica, whether contention results between the first state maintained by the first replica and a second state maintained by the first replica that is based on the order of execution of requests; and
when the contention does not result, updating the second state maintained by the first replica to reflect the execution of the operation using the validated pre-processing result.

13. The non-transitory computer-readable storage medium of claim 12, further operable for:
when the contention results, performing an action based on contention resulting without updating the second state maintained by the first replica to reflect the execution of the operation using the validated pre-processing result.

14. The non-transitory computer-readable storage medium of claim 8, further operable for:
when it is determined the agreement on the validated pre-processing result is not received, determining whether to retry sending of the message to pre-process the operation.

15. A method for pre-processing a request for an operation in a state machine replication system comprising N replicas, the method comprising:
receiving, by a first replica, a message from a second replica in a consensus protocol stage to order the request in an order of execution of requests that defines when to execute the request with respect to another request at the first replica;
determining, by the first replica, information for a pre-processing result of the operation from the message;
performing, by the first replica, a validation of the information for the pre-processing result to determine whether the consensus protocol stage should continue for the request; and
when the consensus protocol stage should continue for the request, performing, by the first replica, the consensus protocol stage to order the request in the order of execution of requests.

16. The method of claim 15, further comprising:
receiving a pre-processing request;
pre-processing the operation to generate a pre-processing result by pre-processing the operation using a first state maintained by the first replica; and
sending information for the pre-processing result to the second replica.

17. The method of claim 16, further comprising:
after determining the order of the request in the order of execution of requests, determining, by the first replica, whether contention results between the first state maintained by the first replica and a second state maintained by the first replica that is based on the order of execution of requests.

18. The method of claim 17, further comprising:
when the contention does not result, updating the second state maintained the first replica to reflect the execution of the operation using the pre-processing result.

19. The method of claim 17, further comprising:
when the contention results, performing an action based on contention resulting without updating the second state maintained by the first replica to reflect the execution of the operation using the validated pre-processing result.

20. The method of claim 15, wherein performing the validation of the information comprises:
determining if a pre-processing result in the information for the pre-processing result is a same result as that generated when pre-processing the operation at the first replica; and
validating a set of signatures from a set of replicas in the information for the pre-processing.

21. The method of claim 15, further comprising:
when the consensus protocol stage should not continue for the request, entering a procedure to indicate a replica is faulty in the state machine replication system.
